(19) United States
(12) Patent Application Publication
(10) Pub. No.: US 2007/0236155 A1
(43) Pub. Date: Oct. 11, 2007

(54) POWER CONVERTER FOR LED MODULE AND RELATED DEVICES THEREOF

(75) Inventors: Chin-Fa Kao, Taipei (TW); Shih-Chung Huang, Taipei (TW); Chung-Che Yu, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: BEYOND INNOVATION TECHNOLOGY CO., LTD., Taipei (TW)

(21) Appl. No.: 11/462,721

(22) Filed: Aug. 7, 2006

(30) Foreign Application Priority Data
Apr. 11, 2006 (TW) 95112797

(51) Int. Cl. H05B 41/36; H05B 41/24

(52) U.S. Cl. 315/247; 315/307

(57) ABSTRACT

A DC/DC converter comprises a switch device, an inductor, a rectifying device and a capacitor. Switch device has a first terminal coupled to a DC power supply and a control terminal receiving a control signal. Inductor has a first terminal electrically coupled to a second terminal of switch device. Rectifying device has a first terminal electrically coupled to the first terminal of inductor. Capacitor has a first terminal electrically coupled to a second terminal of rectifying device, a second terminal electrically coupled to a second terminal of inductor. Switch device is switched between a first and second states based on control signals, the power of DC power supply is stored into inductor when switch device is in the first state; the power stored in inductor is released and provided to capacitor and LED module through rectifying device when switch device is in the second state.

### BACKGROUND OF THE INVENTION

1. Field of the Invention

The invention relates to a power converter, and in particular, to a direct current to direct current (DC/DC) power converter for light emitting diodes (LEDs).

2. Description of the Related Art

Light emitting diodes (LED) convert electrical energy to light energy and are usually used as a light source in variety of environments such as backlight modules. To stabilize the light intensity of LED, a direct current to direct current (DC/DC) converter provides a stable direct current (DC) power supply thereto. FIG. 1 shows a conventional DC/DC converter 1 comprising a DC power supply 100, a boost converter 110, a LED module 105, a load indicator 108 and a signal generator 109. The boost converter 110 also comprises an inductor 101, a diode 102, a power switch device 103 and a capacitor 104.

Referring to FIG. 1, DC power supply 100 supplies a DC voltage to boost converter 110. By fast switching power switch device 103 and storing and releasing energy in the inductor 101 and the capacitor 104, boost converter 110 boosts an input voltage VIN of DC power supply 100 to a DC output voltage VOUT higher than input voltage VIN used by LED module 105. Load indicator 108 is coupled to LED module 105 to detect the current flow through LED module 105 and then send the detected current value to signal generator 109. Signal generator 109 receives the detected current value from the load indicator 108, and outputs a pulse width modulation (PWM) control signal to boost converter 110. Power switch device 103 of the boost converter 110 receives the PWM control signal to adjust the output voltage VOUT of the boost converter 110, and further controls the operation current of LED module 105.

The DC/DC converter of FIG. 1, which using the boost converter, cannot be used when the voltage needed by the LED module 105 is lower than the voltage supplied from the DC power supply 100.

### BRIEF SUMMARY OF INVENTION

The invention provides a DC/DC converter for driving a LED module. An exemplary embodiment of a DC/DC converter for a LED module comprises a switch device, an inductor, a rectifying device and a capacitor. The switch device has a first terminal coupled to a DC power supply, a second terminal and a control terminal receiving a control signal. The inductor has a first terminal electrically coupled to the second terminal of the switch device. The rectifying device has a first terminal electrically coupled to the first terminal of the inductor. The capacitor has a first terminal and a second terminal, in which the first terminal of the capacitor is electrically coupled to a second terminal of the rectifying device and the second terminal of the capacitor is electrically coupled to a second terminal of the inductor. The switch device is switched between a first state and a second state based on the control signal, the power (electrical energy) of the DC power supply is stored in the inductor when the switch device is in the first state; the power stored in the inductor is released and provided to the capacitor and the LED module through the rectifying device when the switch device is in the second state.

When the DC/DC converter according to the invention is used with a LED module, operating current of the LED module can be detected by a load indicator, and generates a load indication signal. The signal generator, coupled to the load indicator, provides a control signal to control the switch device based on the load indication signal, such that the system is stable.

Moreover, a voltage detector and a protection module can also be added to protect both the power converter and user, in which the protection module determines whether the voltage detected by the voltage detector is higher or lower than a certain level and generates an alarm signal based on the comparison result. The signal generator then receives the alarm signal and determines whether to stop turning on the switch device.

### BRIEF DESCRIPTION OF DRAWINGS

The invention can be more fully understood by reading the subsequent detailed description and examples with reference made to the accompanying drawings, wherein:

FIG. 1 is a schematic of a circuit of a conventional LED driver;

FIG. 2 is a schematic illustration of a LED driver according to an embodiment of the invention;

FIG. 3 is a schematic illustration showing the waveform of the control signal SW1, square wave switching signal VD and the output voltage signal VOUT of the FIG. 2;

FIG. 4 is a schematic illustration showing the waveform of the output voltage signal VOUT, the voltage detecting signal SF2, the alarm signal SE and the control signal SW1 of the FIG. 2 in the abnormal state;

FIG. 5(a) is a schematic illustration showing the bias circuit according to an embodiment of the invention; and

FIG. 5(b) is a schematic illustration showing the bias circuit according to another embodiment of the invention.

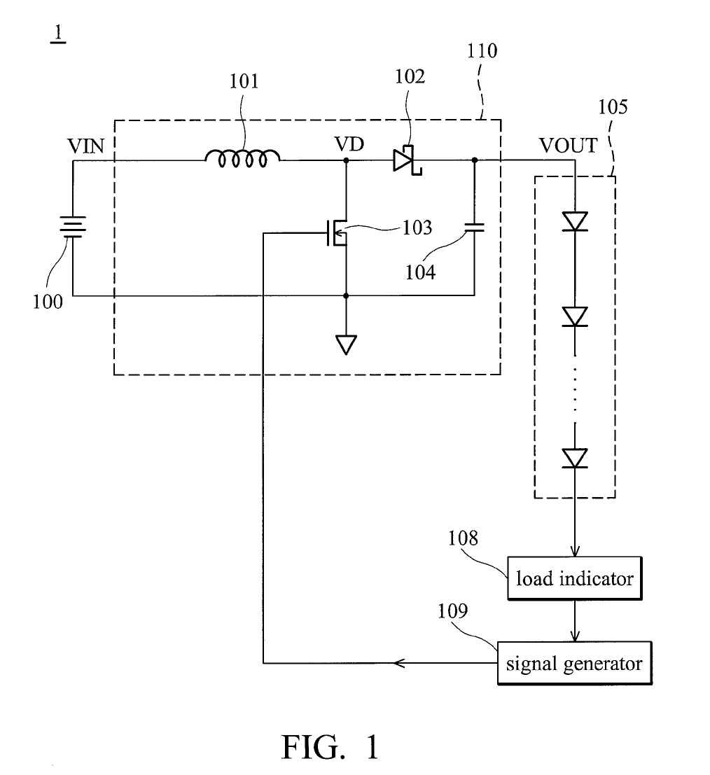

### DETAILED DESCRIPTION OF INVENTION

The following description is of the best-contemplated mode of carrying out the invention. This description is made for the purpose of illustrating the general principles of the invention and should not be taken in a limiting sense. The scope of the invention is best determined by reference to the appended claims.

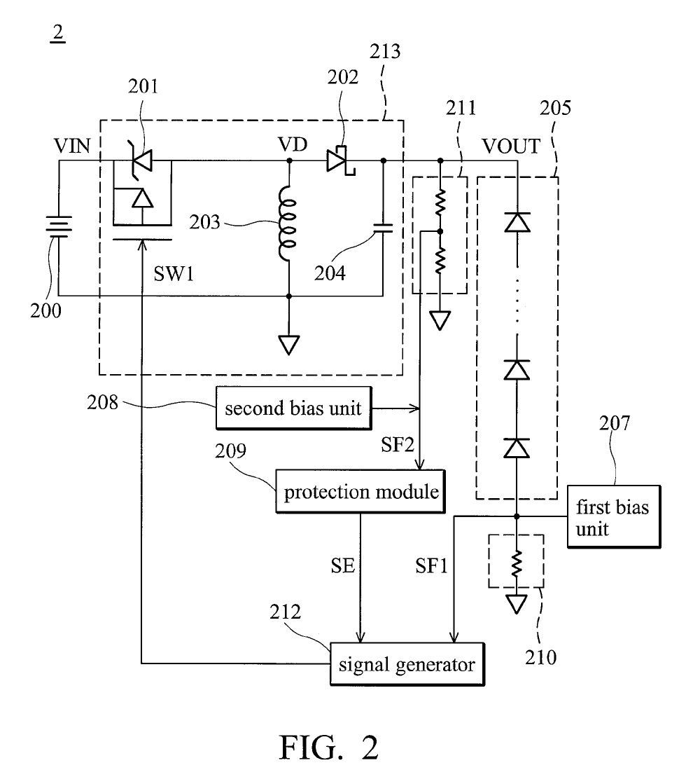

FIG. 2 shows an embodiment of a LED driver according to the invention. LED driver 2 comprises a DC power supply 200, a power converter 213, a first bias unit 207, a second bias unit 208, a protection module 209, a load indicator 210, a voltage detector 211 and a signal generator 212. The power converter 213 also comprises a switch device 201, a rectifying device (eg. diode) 202, an inductor 203 and a output capacitor 204.

As shown in FIG. 2, the first terminal of switch device 201 in power converter 213 is coupled to the DC power supply 200, and the second terminal is coupled to the first terminal of the inductor 203 and the cathode terminal of the diode 202. In this embodiment, the switch device 201 is a PMOS transistor, and the first terminal of the switch device 201 is the source and the second terminal is the drain. The first terminal of the output capacitor 204 is coupled to the anode terminal of diode 202 and the second terminal to the second terminal of inductor 203, such that the output capacitor 204 and the inductor 203 are connected in parallel through the diode 202. The first terminal of the output capacitor 204 outputs an output voltage VOUT, converted by the power converter 213, to drive a load coupled to the output terminal of the power converter 213. For example, in this embodiment, the load is a LED module 205, which consists of at least one LED. The cathode terminal of the LED module 205 is coupled to the output terminal of the power converter 213, that is, the first terminal of the capacitor 204, and the anode terminal to ground.

In this embodiment, a load indicator 210, a voltage detector 211 and a signal generator 212 stabilize the output from the power converter 213 and thus protect the LED driver, the LED module 205 and the user. The load indicator 210 comprises a resistor detecting the operating state of the LED module 205. The resistor has a first terminal coupled to the anode terminal of the LED module 205 and a first bias unit 207, and a second terminal coupled to ground, in which the first bias unit 207 adjusts the level of the load indication signal SF1 output from the load indicator 210 to the signal generator 212, such that the level of the load indication signal SF1 is compatible with signal generator 212. The voltage detector 211 includes two resistors, detecting the output voltage VOUT from the power converter 213 to generate a voltage detection signal SF2. The second bias unit 208 is coupled to the voltage detector 211 to adjust the level of the voltage detection signal SF2, such that the level of the voltage detection signal SF2 is suitable for protection module 209 to receive. The protection module 209 determines whether the output from the power converter 213 is abnormal based on the voltage detection signal SF2 and generates an alarm signal SE.

Two input terminals of the signal generator 212 are respectively coupled to the load indicator 210 and the protection module 209, with output terminal coupled to the control terminal of the power switch device 201, that is, the gate. The signal generator 212 adjusts the operating cycles of the output PWM control signal SW1 based on the load indication signal SF1. The power switch device 201 switches between on and off based on PWM control signal SW1 from the signal generator 212. The power supplied from the DC power supply 200 is provided to the inductor 203 and the LED module 205 when the power switch device 201 is turned on. The power supplied from the DC power supply 200 is stopped, and energy stored in the inductor 203 is provided to the LED module 205 when the power switch device 201 is turned off. The signal generator 212 also determines whether to turn off the power switch device 201 to stop the power supply according to the alarm signal SE.

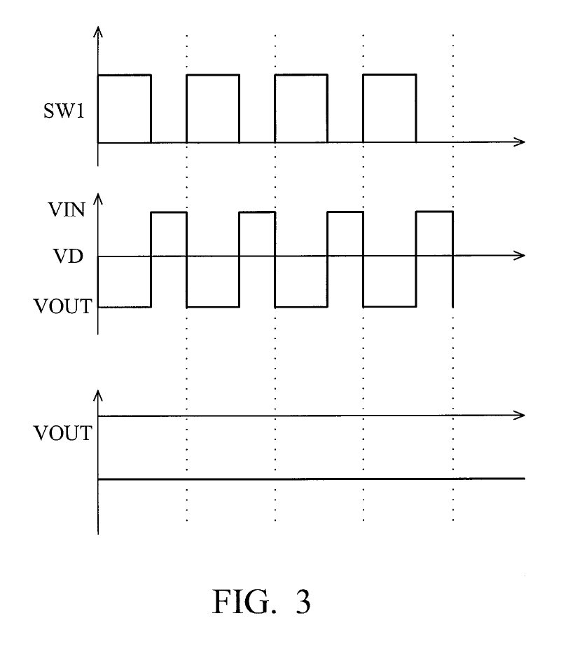

FIG. 3 shows the waveform of the signals VIN, VD and VOUT respectively in normal operation. As shown in the FIG. 3, the switch device 201 in the power converter 213 switches between on and off states in response to the PWM control signal SW1 from the signal generator 212, such that the supplied DC power can assume a square wave signal VD. The switch device 201, in this embodiment, for example, may be a PMOS transistor, but is not limited thereto. Switch device 201 is thus off when the PWM control signal SW1 is in a high level, and on when the PWM control signal SW1 is in a low level. As shown in FIG. 2, when the PWM control signal SW1 is in a low level and the switch device 201 on, the DC power supply 200 is coupled to ground through the inductor 203, such that the current flow through the inductor 203 increases accordingly with time. When the PWM control signal SW1 is in a high level and the switch device 201 off to maintain the current continuity of an inductor, the current flows through both the second terminal of the inductor 203 and the LED module 205, and then back to the first terminal of the inductor 203. Thus, the electrical energy stored in the inductor 203 is released and transferred to the capacitor 204 and the LED module 205. Voltage across capacitor 204 is adjusted to a level that can drive the LED module 205. When the voltage across the capacitor 204 is adjusted high enough such that the LED module 205 can perform the aforementioned operations, the polarity of output voltage VOUT generated from the power converter 213 is opposite to that of the input voltage VIN, that is, the ratio of VOUT to VIN is a negative value, possibly ranging from zero to negative infinity. In other words, based on the filter property of the inductor 203 and the capacitor 204, the power converter 213 can transfer the received square signal VD to a DC-like signal VOUT, and provide it to the LED module 205 as an operating voltage for LED module 205. The operating current of LED module 205 bases on its own operating voltage.

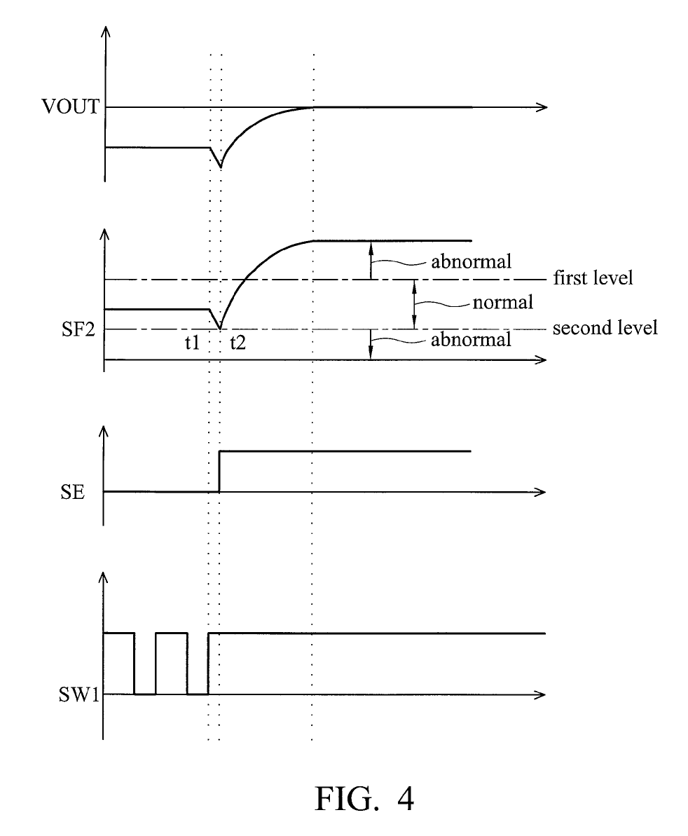

FIG. 4 shows the waveforms of various signals when detecting an abnormal output from the power converter 213. The LED driver 2 sets the range of the operation voltage according to the LED module 205. Referring to FIG. 4, the output voltage VOUT of the power converter 213 increases abnormally at time t1 and exceeds the set range of the operating voltage at time t2. The level of the voltage detection signal SF2 from the voltage detector 211 is synthesized by the second bias unit 208, and is compatible with protection module 209. The protection module 209 compares a first level and a second level corresponding to the set range of the operating voltage with the level of the voltage detection signal SF2 and generates a comparison result as output signal SE to the signal generator 212. When abnormal operating voltage occurs at time t2, that is, the voltage is higher than the first level or lower than the second level, the protection module 209 generates an alarm signal SE to the signal generator 212. The signal generator 212 stops outputting the PWM control signal SW1 to the switch device 201 based on the indication signal SE. Thus, as shown in FIG. 4, the switch device 201 is turned off and the operation is stopped.

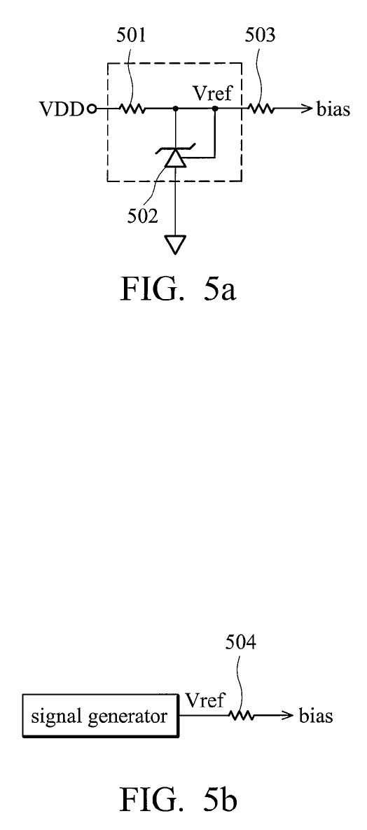

The circuits of the first bias unit 207 and the second bias unit 208, shown in FIG. 2, can be implemented by the circuits shown in FIG. 5(a) or FIG. 5(b). The output voltage VOUT of the power converter 213 may be a negative voltage, such that the voltage signals detected by the load indicator 210 and the voltage detector 211 during normal operation have negative voltages and thus are not compatible with signal operating range of the protection module 209 and the signal generator 212. In this case, the bias unit adjusts the signal level to a positive voltage. As shown in the embodiment of FIG. 5(a), the bias circuit comprises a resistor 501 and a power regulator 502. One terminal of the resistor 501 is coupled to a power supply, for example, a power supply VDD providing the operating voltage for the LED driver. The power regulator 502 is coupled between the other terminal of the resistor 501 and ground to maintain the voltage as a fixed value Vref at the coupling point between the resistor 501 and the power regulator 502. After adding the fixed voltage value Vref into the signal level for adjustment, the signal level can be increased. And external resistor 503 can be adjusted to increase or reduce the amount of level shift. FIG. 5(b) shows another embodiment of the bias circuit according to the invention. As shown, a fixed voltage value Vref is generated from the signal generator 212, with adjustment of resistance of the resistor 504 providing a desired increase in the level of the load indicator signal SF1 or the voltage detection signal SF2.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A light emitting diode driver, comprising:
a power converter receiving an input voltage from a direct current (DC) power supply and converting the input voltage to an output voltage according to a control signal;
a light emitting diode (LED) module comprising at least one LED electrically coupled to the power converter and receiving the output voltage;
a load indicator detecting the operating state of the LED to generate a load indication signal; and
a signal generator coupled to the load indicator, generating a control signal according to the load indication signal;
wherein the voltage magnification of the power converter: the ratio of the input voltage to the output voltage is negative.

2. The light emitting diode driver as claimed in claim 1, wherein the control signal is a pulse width modulation (PWM) signal.

3. The light emitting diode driver as claimed in claim 1, wherein the power converter comprises:
a switch device comprising a first terminal coupled to the DC power supply, a second terminal and a control terminal receiving the control signal;
an inductor comprising a first terminal electrically coupled to the second terminal of the switch device;
a rectifying device comprising a first terminal electrically coupled to the first terminal of the inductor; and
a capacitor comprising a first terminal and a second terminal generating output voltage, wherein the first terminal of the capacitor is electrically coupled to a second terminal of the rectifying device and the second terminal of the capacitor electrically coupled to a second terminal of the inductor.

4. The light emitting diode driver as claimed in claim 1, further comprising a first bias unit, coupled to the load indicator, for adjusting the level of the load indication signal.

5. The light emitting diode driver as claimed in claim 4, wherein the first bias unit comprises:
a reference voltage generator for generating a reference voltage; and
a first resistor, coupled to the reference voltage generator and the load indicator, for adjusting the level of the load indication signal according to the reference voltage.

6. The light emitting diode driver as claimed in claim 5, wherein the reference voltage generator comprises:
a second resistor coupled to a DC power supply; and
a power regulator having a first terminal coupled to the second resistor and a second terminal coupled to ground and providing the reference voltage.

7. The light emitting diode driver as claimed in claim 1, further comprising a voltage detector, detecting the operation voltage of the LED module and generating a voltage detection signal based on a detection result.

8. The light emitting diode driver as claimed in claim 7, further comprising a protection module, generating an alarm signal in response to the voltage detection signal and the signal generator determining whether to stop the power converter according to the alarm signal.

9. The light emitting diode driver as claimed in claim 7, further comprising a second bias unit coupled to the voltage detector, adjusting the level of the voltage detection signal.

10. The light emitting diode driver as claimed in claim 9, wherein the second bias unit further comprises:
a reference voltage generator generating a reference voltage; and
a third resistor, coupled to the reference voltage generator and the load indicator, for adjusting the level of the load indication signal according to the reference voltage.

11. The light emitting diode driver as claimed in claim 10, wherein the reference voltage generator comprises:
a fourth resistor coupled to a DC power supply; and
a power regulator comprising a first terminal coupled to the fourth resistor and a second terminal coupled to ground, providing the reference voltage.

12. The light emitting diode driver as claimed in claim 8, wherein the power converter is stopped by the signal generator when the voltage detection signal indicates that the output voltage exceeds a first predetermined voltage level or lower than a second predetermined voltage level.

13. A direct current to direct current converter, comprising:
a switch device comprising a first terminal coupled to a DC power supply, a second terminal and a control terminal receiving a control signal;
an inductor comprising a first terminal electrically coupled to the second terminal of the switch device;
a rectifying device comprising a first terminal electrically coupled to the first terminal of the inductor; and
a capacitor comprising a first terminal and a second terminal, generating the output voltage,
wherein the first terminal of the capacitor is electrically coupled to a second terminal of the rectifying device and the second terminal of the capacitor is electrically coupled to a second terminal of the inductor; wherein the switch device is switched between a first state and a second state based on the control signal, and power of the DC power supply is stored to the inductor when the switch device is in the first state; the inductor releases the stored power and provides power to the capacitor through the rectifying device when the switch device is in the second state.

14. The direct current to direct current converter as claimed in claim 13, wherein the second terminals of both the capacitor and the inductor are coupled to ground.

15. The direct current to direct current converter as claimed in claim 13, wherein the switch device is a PMOS transistor and the first, second and control terminals of the switch device are source, drain and gate of the PMOS transistor respectively.

16. The direct current to direct current converter as claimed in claim 13, wherein the voltage in the first terminal of the capacitor is lower than the voltage in the second terminal of the capacitor.

17. The direct current to direct current converter as claimed in claim 13, further comprising a signal generator for generating the control signal.

18. The direct current to direct current converter as claimed in claim 17, wherein the first terminal of the capacitor is coupled to and drives a load.

19. The direct current to direct current converter as claimed in claim 18, further comprising a load indicator for generating a load indication signal in response to a state of the load.

20. The direct current to direct current converter as claimed in claim 19, wherein the signal generator generates the control signal based on the load indication signal.

21. The direct current to direct current converter as claimed in claim 19, further comprising a bias unit, coupled to the load indicator, for adjusting the level of the load indication signal.

22. The direct current to direct current converter as claimed in claim 21, wherein the bias unit further comprises:
a reference voltage generator for generating a reference voltage; and
a first resistor, coupled to the reference voltage generator and the load indicator, for adjusting the level of the load indication signal according to the reference voltage.

23. The direct current to direct current converter as claimed in claim 22, wherein the reference voltage generator comprises:
a second resistor coupled to a DC power supply; and
a power regulator having a first terminal coupled to the second resistor and a second terminal coupled to ground, and providing the reference voltage.

24. The direct current to direct current converter as claimed in claim 17, further comprising a protection module, generating an alarm signal by detecting a state in the first terminal of the capacitor, the signal generator determining whether to stop the DC power supply to the inductor by controlling the switch device based on the alarm signal.

25. The direct current to direct current converter as claimed in claim 24, wherein the signal generator instructs the switch device to stop the DC power supply to the inductor when the voltage at the first terminal of the capacitor exceeds a first predetermined voltage level or is lower than a second predetermined voltage level voltage.

26. The direct current to direct current converter as claimed in claim 13, wherein the rectifying device is a diode and the inductor releases the stored power to the load when the switch device is in the second state.

27. A direct current to direct current converter, comprising:
a power converter receiving an input voltage from a DC power supply and converting the input voltage to an output voltage based on a control signal, having:
an inductor electrically coupled to the DC power supply, storing the DC power from the DC power supply; and
a capacitor coupled to the DC power supply and coupled to the inductor in parallel;
a load having at least one LED electrically coupled to the power converter to receive the output voltage;
a load indicator, detecting the operating state of the load to generate a load indication signal; and
a signal generator coupled to the load indicator, generating the control signal according to the load indication signal;
wherein the voltage magnification of the power converter: the absolute value of the input voltage to the output voltage exceeds zero.

28. The direct current to direct current converter as claimed in claim 27, wherein capacitor is coupled to the inductor in parallel through a rectifying device.

29. The direct current to direct current converter as claimed in claim 28, wherein the inductor is coupled to the DC power supply through a switch device.

30. The direct current to direct current converter as claimed in claim 28, wherein the voltage magnification of the power converter is negative.
